(19) United States
(12) Patent Application Publication
(10) Pub. No.: US 2025/0007087 A1
(43) Pub. Date: Jan. 2, 2025

(54) SELF-EXTINGUISHABLE EXTERIOR MATERIAL FOR BATTERY MODULE OR BATTERY PACK

(71) Applicant: REPUBLIC OF KOREA (NATIONAL FORENSIC SERVICE DIRECTOR MINISTRY OF THE INTERIOR AND SAFETY), Wonju-si (KR)

(72) Inventors: Hyun Won LEE, Daejeon (KR); Dong Gyu LEE, Daejeon (KR); Gie Tae LEE, Jincheon-gun (KR); Seung Woo WOO, Gwangmyeong-si (KR); Jong Taek PARK, Wonju-si (KR)

(21) Appl. No.: 18/512,749

(22) Filed: Nov. 17, 2023

(30) Foreign Application Priority Data
Jun. 27, 2023 (KR) 10-2023-0082649

(51) Int. Cl. H01M 50/383; A62D 1/00; H01M 50/224

(52) U.S. Cl. CPC H01M 50/383; A62D 1/0007; H01M 50/224; H01M 2220/20

(57) ABSTRACT

An exterior material for battery module or battery pack includes a metal layer including aluminum or an aluminum alloy and a fire extinguishing agent layer laminated on the metal layer and including a solid fire extinguishing agent for metal fires.

### CROSS REFERENCE TO RELATED APPLICATION

The present application claims priority to Korean Patent Application No. 10-2023-0082649, filed Jun. 27, 2023, the entire contents of which is incorporated herein for all purposes by this reference.

### BACKGROUND

### 1. Field

One or more embodiments relate to a self-extinguishable exterior material for battery module or battery pack, and a method of manufacturing the same.

### 2. Description of the Related Art

Lithium-ion batteries are used as a key component for energy supply in electric vehicles (EV), mobile phones, wearable devices, and energy storage systems (ESS).

Lithium-ion batteries may experience thermal runaway. A thermal runaway phenomenon of a lithium-ion battery refers to a chain reaction of heat generated due to electrochemical reactions of materials inside the battery. The thermal runaway phenomenon of a lithium-ion battery may be caused by a variety of reasons, including battery defects, external shocks, overcharging, and overdischarging. High-temperature heat, smoke, and toxic gases generated by thermal runaway may lead to large-scale fires.

In particular, as the use of electric vehicles increases, the number of ignition cases of electric vehicles is increasing. Even if the direct cause of an electric vehicle's ignition is not the battery, the battery may eventually burn and escalate into a large fire.

Because it is difficult to initially extinguish a fire in an electric vehicle, it is necessary to secure time for drivers, passengers, etc. to evacuate by increasing a time from an ignition stage to thermal runaway during driving or when a contact accident occurs.

### PATENT DOCUMENT

KR 10-2010-0106707 (published on Oct. 4, 2010)

### SUMMARY

One or more embodiments include an exterior material for battery module or battery pack that exhibits a self-fire extinguishing function along with a basic molding function.

One or more embodiments include an exterior material for battery module or battery pack that prevents a fire from spreading even though it is difficult to completely extinguish a fire in an electric vehicle and ensures safety by increasing a time for passengers to evacuate.

According to one or more embodiments, an exterior material for battery module or battery pack includes a metal layer including aluminum or an aluminum alloy and a fire extinguishing agent layer laminated on the metal layer and including a solid fire extinguishing agent for metal fires.

In an embodiment, the metal layer may include a first metal layer and a second metal layer, and the fire extinguishing agent layer may be between the first metal layer and the second metal layer.

In an embodiment, a thickness of either the first metal layer or the second metal layer may be in a range of 0.5 mm to 2 mm.

In an embodiment, a resin layer between the metal layer and the fire extinguishing agent layer may be further included.

In an embodiment, the resin layer may be formed of a film including at least one of polyethylene (PE), polypropylene (PP), polystyrene (PS), and polyethylene-terephthalate (PET).

An exterior case for battery module or battery pack may include the exterior material for battery module or battery pack according to an embodiment, at least in a portion thereof.

A method of manufacturing an exterior material for battery module or battery pack includes sequentially forming a first metal layer, a first resin layer, a fire extinguishing agent layer, a second resin layer, and a second metal layer, wherein the first and second metal layers include aluminum or an aluminum alloy, the first and second resin layers are formed of a film including at least one of PE, PP, PS, and PET, and the fire extinguishing agent layer includes a solid fire extinguishing agent for metal fires.

Additional aspects will be set forth in part in the description which follows and, in part, will be apparent from the description, or may be learned by practice of the embodiments.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a battery module to which a battery module exterior material is applied, according to an embodiment;

FIG. 2 is a schematic view of a battery pack to which a battery pack exterior material is applied, according to an embodiment; and

FIG. 3 is a flowchart illustrating a method of manufacturing an exterior material for battery module or battery pack, according to an embodiment.

### DETAILED DESCRIPTION

Hereinafter, embodiments will be described in detail with reference to the accompanying drawings. The same reference numerals are used to denote the same elements, and repeated descriptions thereof will be omitted.

It will be understood that although the terms “first,” “second,” etc. may be used herein to describe various components, these components should not be limited by these terms.

An expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

It will be understood that when a layer, region, or component is referred to as being “formed on” another layer, region, or component, it can be directly or indirectly formed on the other layer, region, or component. That is, for example, intervening layers, regions, or components may be present.

Sizes of elements in the drawings may be exaggerated for convenience of explanation. In other words, since sizes and thicknesses of components in the drawings are arbitrarily illustrated for convenience of description, the following embodiments are not limited thereto.

When a certain embodiment may be implemented differently, a specific process order may be performed differently from the described order. For example, two consecutively described processes may be performed substantially at the same time or performed in an order opposite to the described order.

It will be understood that when a layer, region, or component is connected to another portion, the layer, region, or component may be directly connected to the portion or an intervening layer, region, or component may exist, such that the layer, region, or component may be indirectly connected to the portion.

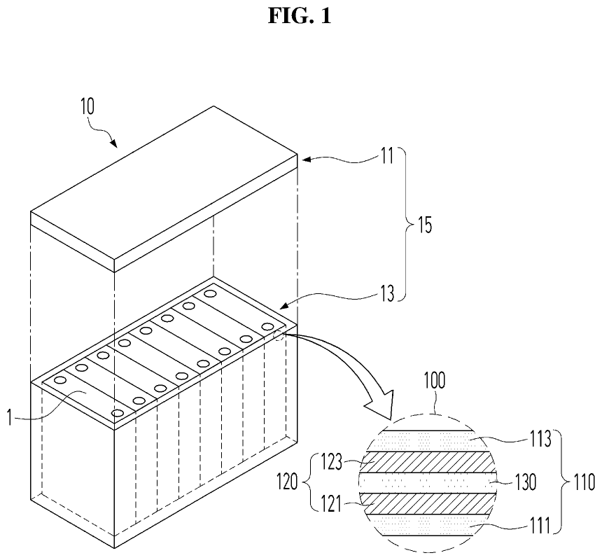

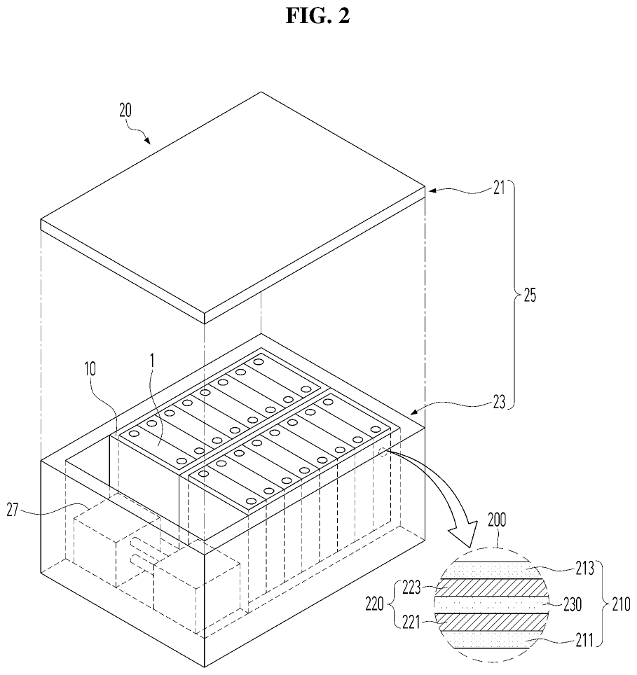

Hereinafter, a self-extinguishable exterior material for battery module or battery pack will be described with reference to FIGS. 1 and 2.

FIG. 1 is a schematic view of a battery module to which a battery module exterior material is applied, according to an embodiment. FIG. 2 is a schematic view of a battery pack to which a battery pack exterior material is applied, according to an embodiment.

A battery cell 1 is a basic unit of a battery that can be used by charging and discharging electrical energy. A battery module 10 is a battery assembly in which a certain number of battery cells 1 are bundled. A battery pack 20 is made by attaching a battery management system (BMS) 27, etc. to the battery module 10, and is the final form of a battery system installed in an electric vehicle.

A plurality of battery cells 1 form the battery module 10, a plurality of battery modules 10 form the battery pack 20, and the battery pack 20 may be built into an electric vehicle.

Referring to FIG. 1, the battery module 10 may accommodate at least one battery cell 1 therein.

A battery module exterior case 15 may form the exterior of the battery module 10 and may protect the battery cell 1 included therein from external shock, heat, and vibration.

The battery module exterior case 15 is not limited to a specific shape as long as it forms the exterior of the battery module 10 and protects the interior. For example, the battery module exterior case 15 may be formed in a hexahedral shape. At this time, the battery module exterior case 15 may include a battery module upper case 11 and a battery module lower case 13. The battery module upper case 11 may have an open lower side, and the battery module lower case 13 may have an open upper side. The battery cells 1 may be laminated vertically or horizontally on the battery module upper case 11 or the battery module lower case 13. Each battery cell 1 may be placed in contact with an adjacent battery cell 1 or may be apart from each other at a certain interval.

Referring to FIG. 2, the battery pack 20 may accommodate at least one battery module 10 therein.

A battery pack exterior case 25 may form the exterior of the battery pack 20 and may protect the battery module 10 included therein from external shock, heat, and vibration.

The battery pack exterior case 25 is not limited to a specific shape as long as it forms the exterior of the battery pack 20 and protects the interior. For example, the battery pack exterior case 25 may be formed in a hexahedral shape. At this time, the battery pack exterior case 25 may include a battery pack upper case 21 and a battery pack lower case 23. The battery pack upper case 21 may have an open lower side, and the battery pack lower case 23 may have an open upper side. The battery modules 10 may be laminated vertically or horizontally on the battery pack upper case 21 or the battery pack lower case 23.

### Exterior Material for Battery Module or Battery Pack

A battery module exterior material 100 according to embodiments may be included in the exterior of the battery module 10, and the battery module exterior case 15 may include the battery module exterior material 100 according to embodiments, at least in a portion thereof.

For example, the battery module exterior material 100 according to an embodiment may constitute both the battery module upper case 11 and the battery module lower case 13 in the battery module exterior case 15. In addition, the battery module exterior material 100 according to an embodiment may constitute only one of the battery module upper case 11 or the battery module lower case 13.

In addition, a battery pack exterior material 200 according to embodiments may be included in the exterior of the battery pack 20, and the battery pack exterior case 25 may include the battery pack exterior material 200 according to embodiments, at least in a portion thereof.

For example, the battery pack exterior material 200 according to an embodiment may constitute both the battery pack upper case 21 and the battery pack lower case 23 in the battery pack exterior case 25. In addition, the battery pack exterior material 200 according to an embodiment may constitute only one of the battery pack upper case 21 or the battery pack lower case 23.

Referring to FIG. 1, the battery module exterior material 100 according to an embodiment may include a metal layer 110, a fire extinguishing agent layer 130, and a resin layer 120. In addition, referring to FIG. 2, the battery pack exterior material 200 according to an embodiment may include a metal layer 210, a fire extinguishing agent layer 230, and a resin layer 220.

Hereinafter, the battery module exterior material 100 and the battery pack exterior material 200 according to an embodiment have the same configuration and will be described together.

The metal layers 110 and 210 may include aluminum or an aluminum alloy.

As an example, the metal layers 110 and 210 may be made of aluminum.

Aluminum is a highly versatile metal, resistant to low temperatures and lightweight. Although aluminum is lightweight, it has high strength-to-weight ratio. In addition, aluminum is malleable and ductile, so it may be formed into desired shapes using various technologies such as casting, forging, rolling, extrusion, and bending. A melting point of aluminum is approximately 660° C., and compared to iron (melting point 1530° C.) and copper (melting point 1080° C.), the melting point is relatively low, allowing complex shapes to be manufactured.

In addition, aluminum may be formed into an alloy by adding other metals such as copper, magnesium, and zinc to ensure mechanical strength. Depending on the purpose, the metal layers 110 and 210 may include aluminum or an aluminum alloy.

The metal layers 110 and 210 may include first metal layers 111 and 211 and second metal layers 113 and 213. A thickness of any of the first metal layers 111 and 211 and the second metal layers 113 and 213 may be in a range of 0.5 mm to 2 mm. This is to ensure that the metal layers 110 and 210 maintain a shape of the exterior materials 100 and 200 and may be melted quickly when the metal layers 110 and 210 reach a certain temperature.

For example, among the first metal layers 111 and 211 or the second metal layers 113 and 213 formed of aluminum, a layer having a thickness in the range of 0.5 mm to 2 mm may constitute an inner side of the battery module/pack external cases 15 and 25 including the battery module/pack exterior materials 100 and 200 in which an internal battery cell 1 or an internal battery module 10 is accommodated.

When a fire occurs in the internal battery cell 1 and the temperature rises, melting occurs in the metal layers 110 and 210 when the temperature reaches the melting point of aluminum (660° C.), and the fire extinguishing agent layers 130 and 230 laminated on the metal layers 110 and 210 may aid in fire extinguishing.

The fire extinguishing agent layers 130 and 230 may include a solid fire extinguishing agent for metal fires and may be laminated on the metal layers 110 and 210. The fire extinguishing agent layers 130 and 230 may be between the first metal layers 111 and 211 and the second metal layers 113 and 213.

For example, when the battery cell 1 ignites, a thin layer of the first metal layers 111 and 211 or the second metal layers 113 and 213 may melt and a solid fire extinguishing agent for metal fires forming the fire extinguishing agent layers 130 and 230 may flow out of the metal layers 110 and 210, helping to extinguish the ignited battery cell 1.

A metal fire (combustible metal fire) is a fire in which combustible metals such as aluminum (AI), magnesium (Mg), sodium (Na), potassium (K), and lithium (Li) burn. Most metal fires exhibit flame temperatures ranging from approximately 2760° C. to 4700° C. Using water or water-based fire extinguishing agents in case of a metal fire is dangerous because the metal reacts with water and generates highly explosive hydrogen.

For example, a solid fire extinguishing agent for metal fires may include at least one of expanded vermiculite, expanded glass, and expanded pearlite. The solid fire extinguishing agent for metal fires may be any one of these, or a combination of two or more.

Expanded vermiculite is a fire-resistant material with excellent absorbency extracted from vermiculite produced by weathering and deterioration of mica. Expanded vermiculite is a very light, economical, and fire-fighting material that extinguishes Class D special fires (combustible metal fires). Expanded vermiculite may be used as a dedicated fire extinguishing agent for lithium-ion battery fires, which react violently with water and generate explosions or flammable gases. Expanded vermiculite acts as a fire extinguisher by absorbing the heat of a fire and forming a new layer on a surface of an oxidized metal to block heat and oxygen.

Expanded glass has a closed-cell structure made of recycled foamed glass with small pores inside a small, lightweight sphere. Expanded glass may be used to extinguish fires of combustible metals (Al, Mg, or Na) and lithium-ion batteries. Expanded glass, similar to expanded vermiculite, has a small specific gravity and is lightweight, making it suitable for field use, but its unit price is higher than expanded vermiculite, making it less economical.

Expanded pearlite is expanded by crushing pearlite ore including about 2 to 6% of volatile components and then rapidly heating it to 800 to 1150° C., and has similar properties to expanded vermiculite.

The resin layers 120 and 220 may be between the metal layers 110 and 210 and the fire extinguishing agent layers 130 and 230. The resin layers 120 and 220 may fix the fire extinguishing agent layers 130 and 230 and maintain mechanical strength of the exterior materials 100 and 200. Adhesives may be used to connect the resin layers 120 and 220 and the fire extinguishing agent layers 130 and 230 and to connect the metal layers 110 and 210 and the resin layers 120 and 220.

For example, when the resin layers 120 and 220 are PP films, an adhesive used may be polypropylene adhesive, structural adhesive (e.g., epoxy adhesive, cyanoacrylate adhesive, etc.), polyolefin adhesive, heat-activated adhesive (e.g., hot melt adhesive), etc.

The resin layers 120 and 220 may include first resin layers 121 and 221 and second resin layers 123 and 223. The fire extinguishing agent layers 130 and 230 are between the first resin layers 121 and 221 and the second resin layers 123 and 223, so that the fire extinguishing agent layers 130 and 230 may be fixed.

The resin layers 120 and 220 may be formed of a film including at least one of polyethylene (PE), polypropylene (PP), polystyrene (PS), and polyethylene-terephthalate (PET).

PE is crystalline thermoplastic plastic with high toughness and excellent chemical resistance.

PP is a synthetic resin made by polymerizing propylene, and has light weight, moisture resistance, and durability due to high tensile strength. Safety may be ensured because PP does not emit environmental hormones.

PS is a synthetic polymer made from a monomer of styrene.

PET is a relatively high-density polyester resin and is crystalline or amorphous thermoplastic.

As a specific example, the first metal layers 111 and 211 and the second metal layers 113 and 213 are formed of aluminum, the first resin layers 121 and 221 and the second resin layers 123 and 223 are formed of PP film, and the fire extinguishing agent layers 130 and 230 may include expanded vermiculite. An adhesive connecting each layer may be an adhesive for PP film as described above.

Therefore, when the battery cell 1 ignites, melting begins when a temperature of the first metal layers 111 and 211 or the second metal layers 113 and 213 close to the battery cell 1 reaches 660° C. Expanded vermiculite in the exterior materials 100 and 200 may help with fire extinguishment by blocking heat and oxygen as it moves into a space where the battery cell 1 is located.

### Method of Manufacturing Exterior Material for Battery Module or Battery Pack

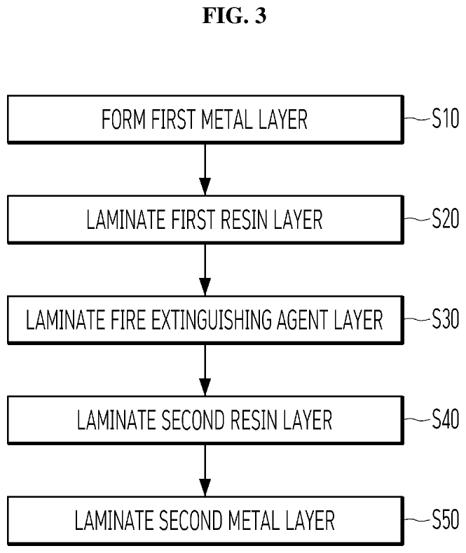

Hereinafter, a method of manufacturing an exterior material for battery module or battery pack according to an embodiment will be described with reference to FIG. 3. FIG. 3 is a flowchart illustrating a method of manufacturing an exterior material for battery module or battery pack, according to an embodiment. The exterior material for battery module or battery pack according to an embodiment has been described in detail above, and the method of manufacturing the exterior material for battery module or battery pack and related content will be described below.

The first metal layers 111 and 211, the first resin layers 121 and 221, the fire extinguishing agent layers 130 and 230, the second resin layers 123 and 223, and the second metal layers 113 and 213 may be sequentially formed and laminated (operations S10, S20, S30, S40, and S50).

In more detail, in operation S10, the first metal layers 111 and 211 are formed, in operation S20, one side of the first resin layers 121 and 221 is laminated on one side of the first metal layers 111 and 211 so that they correspond to each other, in operation S30, one side of the fire extinguishing agent layers 130 and 230 are laminated on the other side of the first resin layers 121 and 221 so that they correspond to each other. In operations S40 and S50, the other side of the fire extinguishing agent layers 130 and 230 and one side of the second resin layers 123 and 223, and the other side of the second resin layers 123 and 223 and one side of the second metal layers 113 and 213 are sequentially laminated so that they correspond to each other.

At this time, operations S10 to S50 may be performed sequentially or in reverse order.

The first metal layers 111 and 211 and the second metal layers 113 and 213 may include aluminum or an aluminum alloy. Because aluminum is easy to form and has a low melting point, when the internal battery cell 1 ignites, a temperature of aluminum rises and aluminum melts when it reaches a melting point, and a solid fire extinguishing agent for metal fires included in the fire extinguishing agent layers 130 and 230 may help extinguish the fire.

A thickness of any of the first metal layers 111 and 211 and the second metal layers 113 and 213 may be in a range of 0.5 mm to 2 mm. Among the first metal layers 111 and 211 and the second metal layers 113 and 213, a thickness of a layer adjacent to the battery cell 1 needs to be thin to enable early fire suppression.

The first resin layers 121 and 221 and the second resin layers 123 and 223 are formed of a film including at least one of PE, PP, PS, and PET. The first resin layers 121 and 221 and the second resin layers 123 and 223 surround the fire extinguishing agent layers 130 and 230 and may maintain their shape.

The fire extinguishing agent layers 130 and 230 may include a solid fire extinguishing agent for metal fires.

For example, a solid fire extinguishing agent for metal fires may include at least one of expanded vermiculite, expanded glass, and expanded pearlite. The solid fire extinguishing agent for metal fires may be any one of these, or a combination of two or more.

An adhesive may be used when laminating each layer in each operation (S10, S20, S30, S40, and S50). At this time, as described above, the adhesive may be selected considering characteristics of the resin layers 120 and 220.

A battery module or battery pack using the exterior material for battery module or battery pack according to an embodiment may be applied to an electric vehicle, a hybrid electric vehicle, an electric two-wheeled vehicle, etc.

As described above, according to embodiments, safety may be ensured by maintaining the existing electric vehicle structure and automatically extinguishing an initial fire when a battery ignites, thereby increasing a time for passengers to evacuate.

In addition, according to embodiments, a fire extinguishing function may be exerted without a separate device when a battery ignites while maintaining mechanical strength.

In addition, according to embodiments, although it is difficult to completely extinguish a fire in an electric vehicle, it is possible to prevent the fire from spreading, and in a case of a local fire, unignited batteries may be reused.

The description herein is for describing the disclosure and numerous modifications and adaptations will be readily apparent to one of ordinary skill in the art without departing from the spirit and scope of the disclosure.

In this regard, the present embodiments may have different forms and should not be construed as being limited to the descriptions set forth herein. While the disclosure has been particularly shown and described with reference to embodiments thereof, it will be understood that various changes in form and details may be made therein without departing from the spirit and scope of the following claims.

What is claimed is:

1. An exterior material for battery module or battery pack comprising:
a metal layer comprising aluminum or an aluminum alloy; and
a fire extinguishing agent layer laminated on the metal layer and comprising a solid fire extinguishing agent for metal fires.

2. The exterior material for battery module or battery pack of claim 1, wherein the metal layer comprises a first metal layer and a second metal layer, and the fire extinguishing agent layer is between the first metal layer and the second metal layer.

3. The exterior material for battery module or battery pack of claim 2, wherein a thickness of either the first metal layer or the second metal layer is in a range of 0.5 mm to 2 mm.

4. The exterior material for battery module or battery pack of claim 1, further comprising:
a resin layer between the metal layer and the fire extinguishing agent layer.

5. The exterior material for battery module or battery pack of claim 4, wherein the resin layer is formed of a film including at least one of polyethylene (PE), polypropylene (PP), polystyrene (PS), and polyethylene-terephthalate (PET).

6. An exterior case for battery module or battery pack comprising the exterior material for battery module or battery pack of claim 1, at least in a portion thereof.

7. A method of manufacturing an exterior material for battery module or battery pack, the method comprising:
sequentially forming a first metal layer, a first resin layer, a fire extinguishing agent layer, a second resin layer, and a second metal layer,
wherein the first and second metal layers comprise aluminum or an aluminum alloy,
the first and second resin layers are formed of a film comprising at least one of PE, PP, PS, and PET, and
the fire extinguishing agent layer comprises a solid fire extinguishing agent for metal fires.
